(19) United States
(12) Patent Application Publication
(10) Pub. No.: US 2015/0166210 A1
(43) Pub. Date: Jun. 18, 2015

(54) Accurate Product Placement

(71) Applicant: S.C. Johnson & Son, Inc., Racine, WI (US)

(72) Inventors: David J. Schram, Franklin, WI (US); Courtney F. Kohn, Whitefish Bay, WI (US); Shaina Ashare, Chicago, IL (US); Jessie Maldonado, Racine, WI (US); David W. Rieske, Rogers, AR (US); Lutanin Rasavong, Rogers, AR (US)

(73) Assignee: S.C. Johnson & Son, Inc., Racine, WI (US)

(21) Appl. No.: 14/104,896

(22) Filed: Dec. 12, 2013

(51) Int. Cl. B65C 9/40; G06Q 90/00; B65D 25/20

(52) U.S. Cl. CPC B65C 9/40; B65D 25/205; G06Q 90/00

(57) ABSTRACT

A multiple-way matching or correlation process guides placement of a particular product at a target placement location. The process may include providing a product package that includes a non-textual placement guidance symbol externally visible on the product package and providing a product container that includes the non-textual placement guidance symbol externally visible on the product container. The process may include providing one or more labels adapted for placement at different locations proximate to the target placement location for the particular product. The labels may include the non-textual placement guidance symbol to visually guide stocking of the particular product to the target placement location. Correlation (e.g., through exact matching) between the non-textual placement guidance symbol on the packaging or container with the non-textual placement guidance symbols on the labels allows for efficient and accurate placement of the particular product at the target placement location.

### TECHNICAL FIELD

This disclosure relates to product placement, e.g., on shelves at a point of sale. In particular, this disclosure relates to repeatable, successful, and accurate product placement.

### BACKGROUND

Enormous amounts of time, money, and other resources are expended daily in the manufacture, distribution, and sale of products across the United States. Retailers present goods for sale to consumers through product displays or other presentment areas on a sales floor. Retailers may assign specific stocking locations for products to increase customer exposure and target increased sales. Accurate, efficient placement and restocking of products in desired placement locations can drive increased sales of these products and reduce labor costs.

### BRIEF DESCRIPTION OF THE DRAWINGS

FIG. 1 shows an example of a product package and a product container adapted for a placement guidance process for product placement.

FIG. 2 shows an example of a product presentment area adapted for a placement guidance process.

FIG. 3 shows an exemplary flow for guiding product placement to a target placement location, using multiple placement guidance symbols associated with a particular product.

FIG. 4 shows an example of a product placement area including multiple placement guidance symbols for multiple products.

FIG. 5 shows an example process for implementing product placement guidance for a particular product.

FIG. 6 shows an example process for executing product placement using multiple placement guidance symbols.

### DETAILED DESCRIPTION

The discussion below makes reference to products. A product may refer to any type of item that is manufactured, distributed, presented, offered for sale, or sold. The forms a product may take and the scope of what may constitute a product are nearly limitless. As small set of examples, products include televisions, computers, and other various electronic devices, paper goods, consumable products such as any type of food or drink related products, household appliances and fixtures, air fresheners or other scented products, office supplies, home decor products, cleaning materials or tools, tools, disposable silverware and plating, decorative items, baking products, clothing or other types of outerwear, childcare products, personal hygiene products, over-the-counter medication, and countless more.

The discussion below describes an accurate and efficient method for placement of a product at a target placement location. As described in greater detail below, multiple placement guidance symbols, e.g., one or more non-textual symbols associated with a product, visually guide placement of the particular product at the target placement location. The guidance may result from matching the multiple placement guidance symbols to one another. More generally, correlations between the multiple placement guidance symbols may guide placement of a particular product to the target placement location.

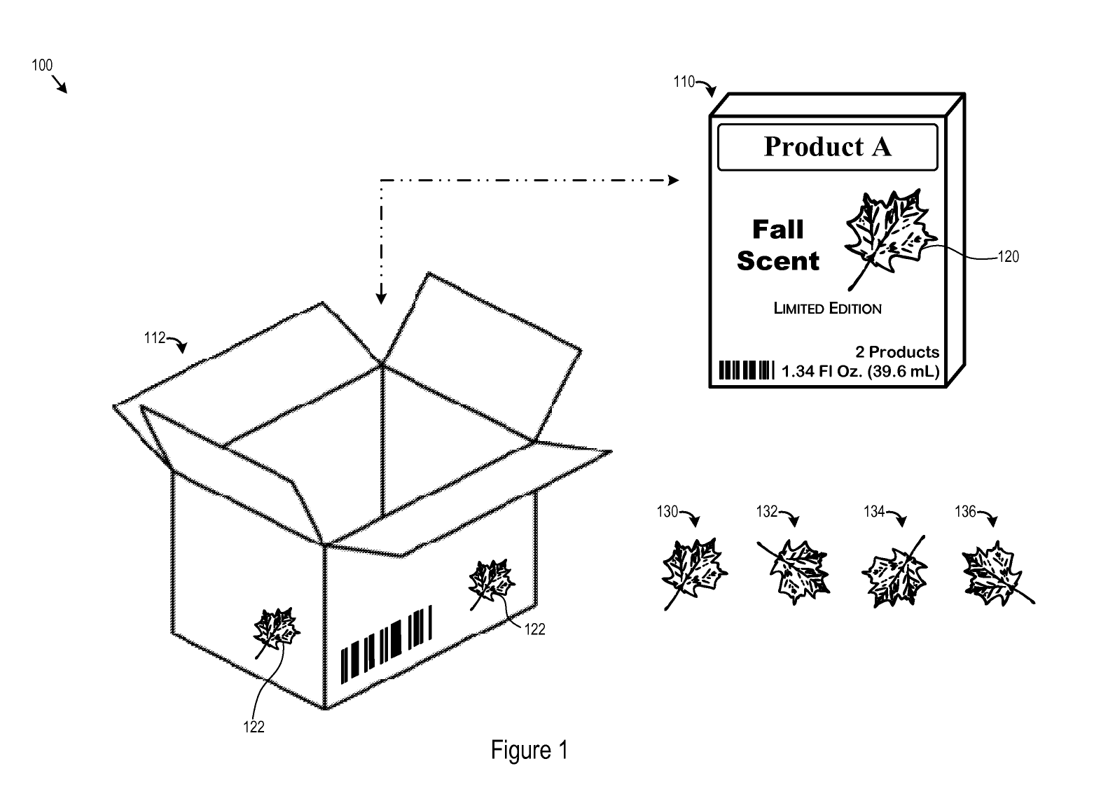

FIG. 1 shows an example of a product package 110 and a product container 112 adapted for guided product placement. The product package 110 may take any number of forms for packaging a particular product. The specific form, design, or characteristics of the product package 110 may vary, for example depending upon the particular product being packaged. In the example shown in FIG. 1, the product package 110 is a box that packages a “Fall Scent” variety of a scent product, such as an air freshener. Additional examples of forms the product package 110 may take include any type of bottle, jar, metallic casing, plastic wrapping, blister pack, styrofoam, netting or bag, cardboard carton, cloth packaging, and many more. The product package 110 may enclose a particular product in whole, in part, or not at all.

The product container 112 holds one or more of the product packages 110. In that regard, the product container 112 may take any form suitable for holding the product packages 110. The product container 112 may, for instance, be a corrugated cardboard box adapted for storing multiple product packages 110. As other examples, the product container 112 may be a shipping container used during distribution of the product packages 110, or a storage container used for storing the product packages 110 at a storage location, such as an inventory location (e.g., a stock room) at a point of sale, or other location.

The product package 110, the product container 112, or both, may be associated with a placement guidance symbol. The placement guidance symbol may be printed, stamped, inscribed, drawn, affixed with a sicker or label, or otherwise placed on, added to, or incorporated into the product package 110 or product container 112. The placement guidance symbol on the product package 110 or product container 112 may be implemented as, or may include, a graphical indicator. The placement guidance symbol may be associated with a specific product and correlate in common to one or more other placement guidance symbols proximate to the target placement location of the specific product. In some variations, a placement guidance symbol is associated with multiple products, e.g., a set or category of products such as chemical-type products, electronics, or other product category or sub-category.

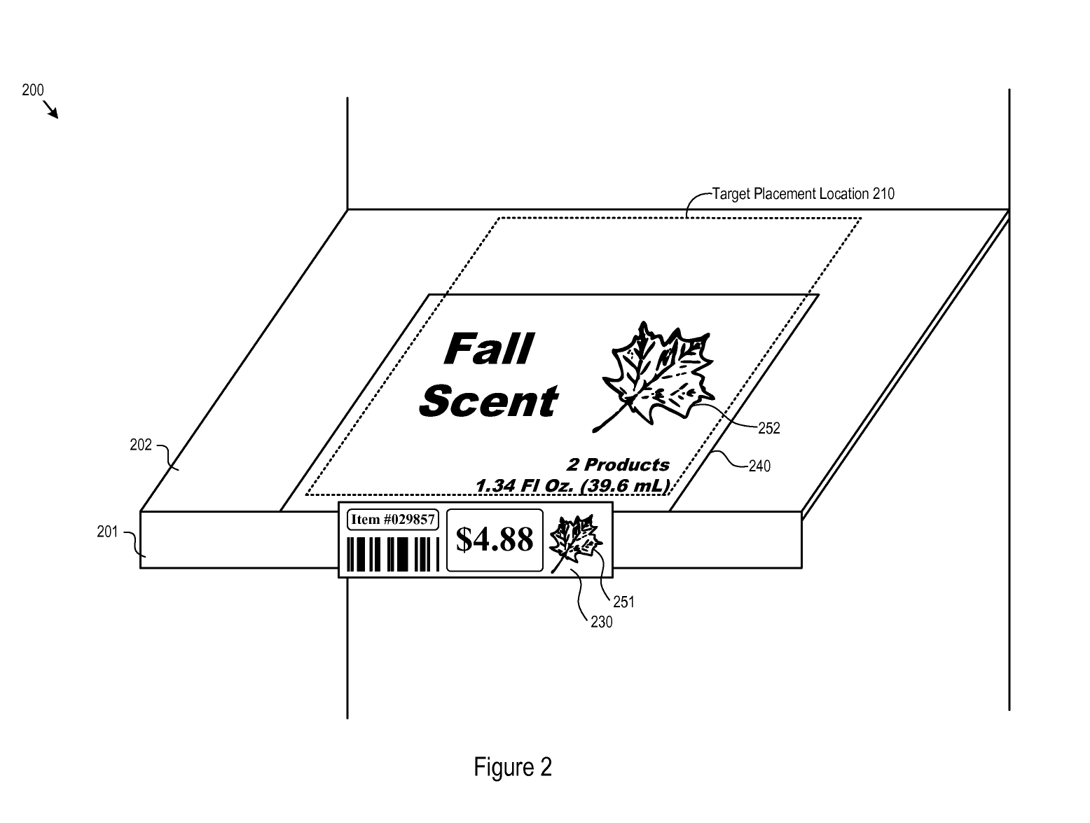

The placement guidance symbols may be non-textual. In that regard, the placement guidance symbols may lack typography, e.g., lack alphanumeric characters, punctuation, or other linguistic elements. The placement guidance symbols do not require graphical representations of textual elements such as alphanumeric characters, such as text, typography, bar codes, Universal Product Codes (UPC), or other electronically scanned sorting or identification codes, for their correlation in common to the product. That is, the placement guidance symbols may correlate in common to the product through their non-textural graphical depictions, icons, or elements (e.g., a leaf symbol). In these variations, the placement guidance symbols may exclude a bar code, Universal Product Code (UPC), quick response (QR) code, and other data or graphical representations of text or typography. Textual elements and electronically scanned codes may of course appear on the product package 110 and product container 112, proximate or distant from the placement guidance symbols. However, the placement guidance symbol itself need not (but may) include textual elements or electronically scanned codes to function in its role in the multiple step matching process. Placement guidance symbols may appear in other locations, some of which are described further below with reference to FIG. 2.

In FIG. 1, the product package 110 includes the externally visible placement guidance symbol 120. Specifically, the example placement guidance symbol 120 in FIG. 1 takes the form of a leaf, without any text, typography, or graphical representation of alphanumeric characters. The placement guidance symbol 120 may be positioned in a particular location, surface, plane, or portion on the product packaging 110, for example on a front panel of the product package 110. As another example, the placement guidance symbol 120 may be positioned on the product package 110 such that the placement guidance symbol 120 is visible when the product package 110 is placed in a stock location at a retailer of the product. In some variations, the placement guidance symbol 120 appears at multiple externally visible locations on the product package 110, e.g., on multiple different sides of the packaging. The placement guidance symbol, regardless of where it appears, may appear in different orientations (e.g., at 0 degree orientation 130, 90 degree orientation 132, 180 degree orientation 134, and 270 degree orientation 136) to facilitate quick recognition of the placement guidance symbol regardless of how the product package 110 is packed or unpacked from, e.g., the product container 112.

Turning to the exemplary product container 112 shown in FIG. 1, the product container 112 may include one or more placement guidance symbols. Specifically, the placement guidance symbol 122 shown in FIG. 1 represents one such placement guidance symbol. In some implementations, the placement guidance symbol 122 on the product container 112 is identical to the placement guidance symbol 120 on the product package 110. In other variations, the placement guidance symbols 122 and 120 may differ in certain respects, such as size, design, or coloring, while optionally sharing a common theme (e.g., a leaf, but of different colors or size; or a leaf and a rake).

The placement guidance symbol 122 is externally visible on the product container 112. Optionally, the placement guidance symbol 122 appears at multiple externally visible locations on the product container 112, e.g., on multiple external panels of the product container 112 as shown in FIG. 1. In particular, the placement guidance symbol 122 may be positioned on particular portions of the product container 112 that are visible when the product container 112 is placed in a particular orientation, such as an orientation that aligns it with other product containers in a storage room of a retailer, or an orientation specified or expected for the product container 112. As a specific example, the placement guidance symbol 122 may be positioned to be externally visible when the product container 112 is aligned on a storage rack in a retailer stock room before or after stocking of the product on a sales floor.

As described above, a product package 110 and/or product container 112 may include non-textual placement guidance symbols that correlate and associate in common to the particular product stored in the product package 110. Specifically, in the example of FIG. 1, the leaf placement guidance symbol 120 on the product package 110 correlates to the leaf placement guidance symbol 122 on the product container 112.

While two exemplary locations for the placement guidance symbol are presented in FIG. 1 on the product package 110 and the product container 112, any variation is possible for positioning the placement guidance symbol for identifying a particular product associated with the placement guidance symbol. For example, the particular product itself may additionally or alternatively visually depict the placement guidance symbol. In this example, the product package 110 for the particular product may be transparent or only cover a portion of the particular product such that the placement guidance symbol on the particular product itself is externally visible for guiding placement of the particular product. As another example, the particular product may not include a product package 110, and a multiple-way correlation may be established using the placement guidance symbol externally visible on the product itself. As yet another example, one or more portions of the product container 112 may be transparent such that the placement guidance symbol on a product package 110 or on the particular product itself is visible through the product container 112. In that case, the product container 112 may or may not include additional placement guidance symbols. As another example, a placement guidance symbol may be implemented through Ultraviolet (UV) ink on the product package 110 and/or product container 112. A product placement symbol may be implemented as an electronic chip that guides placement of a product through electronic recognition or by emitting visual or audio indicators. In some variations, the placement guidance symbol is presented on a modular plan, which may guide configuring of product placement areas (e.g., shelves). In some variations, the placement guidance symbol may be presented on advertisements, circulars, or other media presented to a consumer to guide consumers to a particular product.

As will be described in more detail below, the placement guidance symbols on the product package 110 and product container 112 may correlate in common to additional placement guidance symbols present at the desired or target placement location for the particular product. That is, a product placement area (e.g., a store shelf) may include one or more placement guidance symbols proximate to a target placement location of the particular product that guide placement of the product to the target placement location. In particular, the product placement area may include placement guidance symbols that correlate or match in common to the particular product. One such example is presented next in FIG. 2.

FIG. 2 shows an example of a product placement area 200 adapted to guide product placement using placement guidance symbols. A product placement area may refer to any location where a product can be placed. Examples include any type of product display or presentment area on a sales floor (e.g., a shelf, a rack, a stand, a floor display, or any other location), a storage area for a product in a back room of a product retailer, an inventory storehouse for the product (e.g., as maintained by the product manufacturer, a distributor, or retailer), areas across a distribution channel used for placement of a product, in a private residence or consumer's home, receiving locations at a distribution facility, inventory monitoring locations in a supply chain, or others. The product placement area 200 may include a target placement location 210 for the product, which may refer to any predetermined location designated for placement of a particular product. The target placement location 210 may, for example, be a desired stock location on a sales floor for a particular product.

To illustrate, the product placement area 200 of FIG. 2 is a store shelf that supports general placement of any number of products, e.g., for presentment to retail consumers. In the example of FIG. 2, the store shelf includes a shelf header 201, e.g., a front panel of a shelf, and shelf surface 202, e.g., a flat or horizontal surface supporting placement of products. However, other shelves may include other structures, e.g., separating walls or other barriers, and any structure of any product placement area 200 may include placement guidance symbols.

The store shelf may include a specific portion designated as a target placement location for a particular product. FIG. 2 depicts a target placement location 210, e.g., the specific portion of the shelf designated for the “Fall Scent” version of Product A, which may be a liquid electric air freshener for example. The target placement location 210 for a particular product may be specified or designated using a planogram or other product layout data. To visually guide placement of a product at the target placement location 210, the product placement area 200 may include one or more placement guidance symbols, positioned proximate to the target placement location 210. These placement guidance symbols may correlate in common to the particular product that should be placed at the target placement location 210. The placement guidance symbols facilitate actual placement of the particular product at the target placement location 210, e.g., by comparison to and through determining correlation with the placement guidance symbols on the product package 110 and/or product container 112. Some exemplary locations where multiple-way placement guidance symbols may be positioned are discussed next.

As a first exemplary location, a shelf header label 230 may include a placement guidance symbol used for guiding placement of the particular product at the target placement location 210. The shelf header label 230 may be adapted for placement at a location proximate to the target placement location 210, e.g., across or over the shelf header 201. The shelf header label 230 can specify information related to a particular product, including, as examples, a purchase price, product bar code, item number, stock keeping unit (SKU), or any other associated information. The shelf header label 230 in FIG. 2 includes the placement guidance symbol 251, but the placement guidance symbol may appear directly on the shelf header 201 without using a shelf header label. The placement guidance symbol 251 may correlate in common with the placement guidance symbol 120 of the product package 110, the placement guidance symbol 122 of the product container 112 for a particular product, and/or any other placement guidance symbols positioned in the product placement area 200 or depicted on other containers for the product. The placement guidance symbol 251 may be positioned to cover a specific section of the shelf header label 230 or sized to cover a particular ratio of the shelf header label 230.

As a second exemplary location for providing a placement guidance symbol in a product placement area 200 is the shelf surface 202 itself. In that regard, a shelf surface label 240 may include a placement guidance symbol used to guide placement of the particular product at the target placement location 210. The shelf surface label 240 may be positioned across part, or all, of the shelf surface 202. Optionally, the shelf surface label 240 includes an attachment feature for holding to the shelf surface 202, e.g., a magnetic surface, adhesives, tie downs, snaps or buttons, Velcro® or other fasteners, and the like. The shelf surface label 240 in FIG. 2 includes the placement guidance symbol 252. Optionally, the shelf surface label 240 includes other identifying information for the particular product associated with the shelf surface label 240. The placement guidance symbol 252 may correlate in common with the placement guidance symbol 120 of the product package 120, the placement guidance symbol 122 of the product container 112 for a particular product, the placement guidance symbol 251 of the shelf header label 230, and/or any other placement guidance symbols positioned in the product placement area 200 or depicted on other containers for the product.

The placement guidance symbol 252 may be positioned on the shelf surface label 202 according to any number of visibility criteria. For instance, the placement guidance symbol 252 may be positioned such that at least a part of the placement guidance symbol 252 is visible even when product packages for the particular product are placed (e.g., stocked) at the target placement location over the shelf surface label 240. As another example, the placement guidance symbol 252 may be positioned at a point in the shelf surface label 240 such that the placement guidance symbol 252 becomes visible when a predetermined amount of the product has been removed from the target placement area, which may depend on the dimensions of the product package 110 for the particular product. In that regard, the placement guidance symbol 252 may provide a restocking indication, e.g., when part, or all, of the symbol 252 becomes visible on the shelf. When visible, a consumer may see the placement guidance symbol 252 and, for example, request the retailer to restock a product associated with the now-visible placement guidance symbol 252.

While two exemplary placement guidance symbol locations are presented in the shelf header label 230 and shelf surface label 240, any number of additional or alternative placement guidance symbol locations, orientations, or other variation in positioning the placement guidance symbol in the product placement area 200 are possible. In some implementations, a placement guidance symbol may be positioned at the back portion of a shelf, e.g., along a vertical plane on a back wall of a shelf. As another example, the product placement area 200 may include a hook (e.g., peg hook) to display a particular product. A hook label with a placement guidance symbol may be positioned on or proximate to the hook. In some variations, a label in the product placement area 200 may depict multiple placement guidance symbols. The multiple placement guidance symbols may include symbols that together correlate in common to the same particular product or symbols that are respectively associated with different products, product types, or product versions. As another exemplary location, the placement guidance symbol may be positioned in an endcap of an aisle on a sales floor.

The positioning of one or more placement guidance symbols in a product placement area 200 may vary depending on the characteristics of the area 200 as well as the target placement location of a particular product. As additional examples, the placement guidance symbol may be positioned on the floor proximate to a target placement location or from a label hanging down from a ceiling to location proximate to the target placement location. As other examples, the placement guidance symbol may be positioned on or depicted through a removable flap, electronic display, hanger display, within glass encasing for a product, or via any other visual display proximate to the target placement location for the particular product. Accordingly, a product placement area 200 may be adapted for enhanced placement through multiple, redundant placement guidance indicia (e.g., symbols) positioned proximate to the target placement location for the product. In some variations, a placement guidance symbol may be associated with multiple products, and visually guide stocking to a general placement area for one or more products, e.g., an electronics section of a retailer.

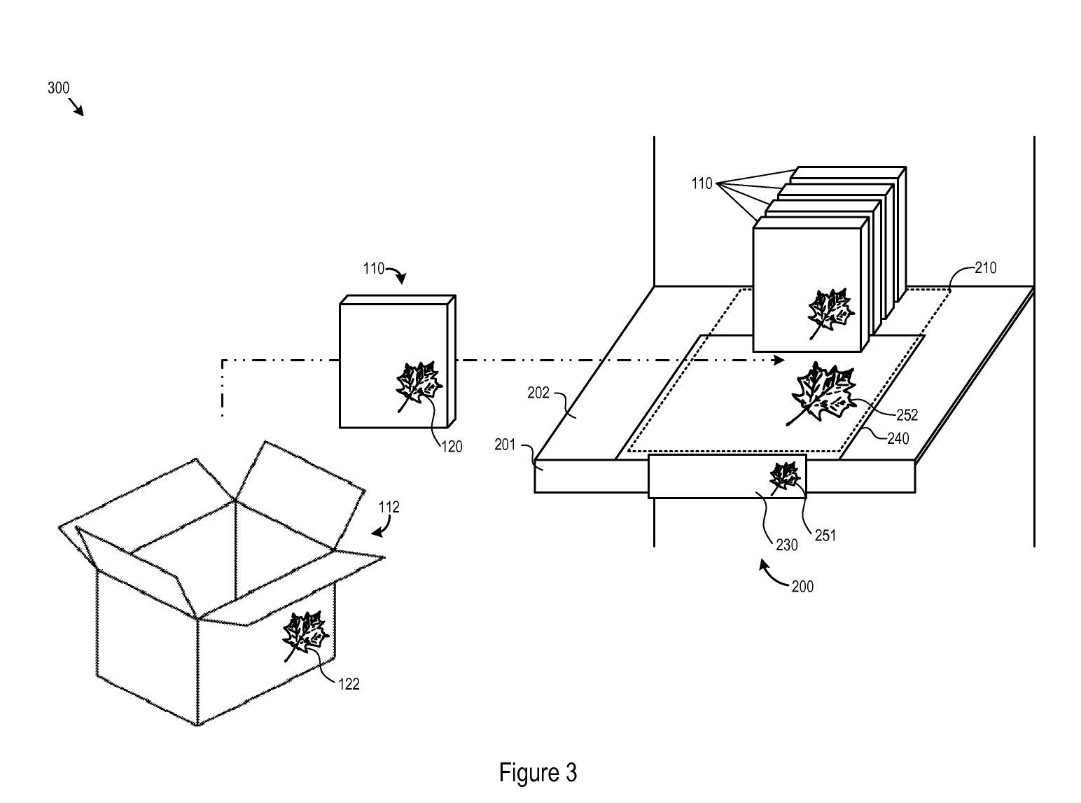

FIG. 3 shows an exemplary flow 300 for guiding product placement to a target placement location, using placement guidance symbols associated with a particular product. That is, the flow 300 illustrates how an individual may employ, e.g., a multiple-way symbol correlation process for accurate placement of a particular product at a target placement location. As one example, an employee of a retailer may perform the flow 300 as part of a product stocking process to place the particular product at the target placement location for the particular product.

An individual may determine a correlation between placement guidance symbols by identifying an exact match between the placement guidance symbols, i.e., when the multiple placement guidance symbols are identical. Note that an exact match is not always necessary to determine a correlation between placement guidance symbols. Instead, a correlation between placement guidance symbols may be established between non-identical placement guidance symbols, to drive more accurate placement of product. As one example, a correlation may occur when the correlation strength between placement guidance symbols exceeds a correlation threshold, e.g., when more than a predetermined number, percentage, or ratio of characteristics shared between the placement guidance symbols are identical. However, correlation between placement guidance symbols may be made in other ways that are not necessarily formalistically analytic. For example, a correlation may be determined between two non-identical placement guidance symbols by direct cognitive recognition that the two symbols represent the same product.

Determining whether a correlation exists between placement guidance symbols may be accomplished according to a comparison of the respective characteristics of the guidance placement symbols. For instance, the correlation may exist when two placement guidance symbols have the same size and color, the same shape and color, just the same shape, or any other permutation of characteristics of the placement guidance symbols are the same. The characteristics may be, as examples, visual (e.g., shape and color), haptic (e.g., soft, hard, or textured), aural (e.g., the symbol is electronic and plays a sound when moved), or olfactory (e.g., the symbol exudes a certain smell, like pine needles). An olfactory symbol may be incorporated in, for example, a “scratch-and-sniff” label of a product package or shelf label. Whether or not the correlation processes finds a correlation or match between symbols may depend on any pre-defined set of correlation criteria. The criteria may be that all characteristics are identical, thus requiring an exact correlation or match. However, the criteria may be that only shape, or color, or size of the symbols match, thereby allowing non-exact matches or correlations to trigger product placement.

Turning back to FIG. 3, the flow 300 includes correlating one or more placement guidance symbols externally visible on a container for the particular product (e.g., the product packaging 110 or the product container 112) with one or more placement guidance symbols positioned within a product placement area 200 and proximate to the target placement location of the particular product. In FIG. 3, the flow 300 includes placement of a particular product upon determining a correlation between any combination of the placement guidance symbols 120, 122, 251, and 252.

In FIG. 3, any combination of correlations between the placement guidance symbols 120, 122, 251, 252 can provide a direction to place the product at the target placement location. For example, a multiple-way correlation may be established by determining a correlation (e.g., an exact match) between one of the placement guidance symbols 251 or 252 proximate to the target placement location and both the placement guidance symbol 122 on the product container 112 as well as the placement guidance symbol 120 one of the product packages 110. Another example of a determination of a multiple-way correlation occurs by correlating the placement guidance symbol 122 externally visible on the product container 112 with the placement guidance symbol 252 positioned on the shelf surface label 240. Upon determining the multiple-way correlation exists, the flow 300 specifies placing the particular product at the target placement location 210, e.g., through placement of the product package 110 at the target placement location 210.

Other examples of multiple way correlations are shown in the tables below, where each column indicates a successful correlation that may result in placement of the product package 110 at the target placement location 210. Any particular correlation establishment may independently set its own criteria for how many correlations, and of what type and/or criteria, are needed prior to placement of a product package 110 at the target placement location 210, with additional correlations generally providing increased accuracy.

2-Way Correlation Between Symbols

| | | | | |
|---|---|---|---|---|
| Placement guidance symbol 122 | X | X | | |
| Product container | | | | |
| Placement guidance symbol 120 | | | X | X |
| Product Package | | | | |
| Placement guidance symbol 251 | X | | X | |
| Shelf Header | | | | |
| Placement guidance symbol 252 | | X | | X |
| Shelf Surface | | | | |

3-Way Correlation Between Symbols

| | | | | |
|---|---|---|---|---|
| Placement guidance symbol 122 | X | X | X | |
| Product container | | | | |
| Placement guidance symbol 120 | X | X | | X |
| Product Package | | | | |
| Placement guidance symbol 251 | X | | X | X |
| Shelf Header | | | | |
| Placement guidance symbol 252 | | X | X | X |
| Shelf Surface | | | | |

4-Way Correlation Between Symbols

| | |
|---|---|
| Placement guidance symbol 122 | X |
| Product container | |
| Placement guidance symbol 120 | X |
| Product Package | |
| Placement guidance symbol 251 | X |
| Shelf Header | |
| Placement guidance symbol 252 | X |
| Shelf Surface | |

The placement guidance symbols are adapted for a particular product and may have variation in strength of association with their particular product. In some implementations, a particular placement guidance symbol may be uniquely assigned to a particular product. In some implementations, the placement guidance symbol represents a characteristic of the particular associated product. The symbol may be indicative of, for example, a scent, taste, color, shape, hardness, or other characteristic of the particular product. Additionally or alternatively, the placement guidance symbol may be a graphical representation of the product itself, such as an image or representation of a specific portion of the product itself.

The placement guidance symbols may be chosen from the results of trial and experimentation, for example, to invoke the intuitive psychological response associated with instinct, emotion, memory, and hard-wired rules of thumb in the brain. These responses are fast responses in the brain that need little cognitive processing power for successful recognition and application, such as responses based on intuition, previous learning, or common sense. Stated another way, the placement guidance symbols may be chosen to invoke the fast and largely unconscious processing system in the brain (sometimes referred to as System 1 processing), as compared to more complicated indicia such as text and bar codes that require slower and much more laborious analysis (sometimes referred to as System 2 processing). In that regard, multiple way correlation through placement guidance symbols may result in increased accuracy and efficiency for product placement as compared to product placement through matching of text strings, bar codes, item numbers, or other typographical indicia associated with the product. Experimental results have shown significant sales increases, in some instances of more than 24%, for particular products stocked at a retailer using the multiple-way correlation process through placement guidance symbols as compared to product stocked using conventional methods, e.g., by matching a 10 digit SKU number and/or identifying a placement location based on item description text. During experimentation with product packages with both placement guidance symbol and UPC codes, retail stockers indicated a preference for and use of visual product stocking using placement guidance symbols instead of conventional stocking methods by matching text strings such as UPC or item numbers.

The placement guidance symbol may differentiate the particular product from other products of the same product type. As one example in FIG. 3, the leaf placement guidance symbols 120, 122, 251, and 252 represent the “Fall Scent” characteristic of Product A (e.g., air freshener) that is associated with the placement guidance symbols 120, 122, 251, and 252. The leaf placement guidance symbols 120, 122, 251, and 252 may differentiate the “Fall Scent” version for product A from other types or versions of product A, e.g., other versions of the same air freshener product but with a different scent, such as a pumpkin scent or an apple scent. In other scenarios, the placement guidance symbol may differentiate the particular product from other different or unrelated products, such as when there is only a single version or type of the particular product.

Using the placement guidance symbols for product placement through multiple-way correlation may improve stocking speed and accuracy. The placement guidance symbols may reduce the complexity of matching a particular product package to a target placement location, e.g., by reducing or eliminating the need to determine product placement through matching of complex text strings, lengthy item numbers, bar codes, or other textual based indicia. In that regard, the multiple-way correlation process may result increased quickness and efficiency in stocking residual inventory. To further reduce matching complexity, the placement guidance symbol for a particular product may be implemented as common or simple visual icon. Additionally, placement guidance symbols with simple color patterns or design may further support efficient and accurate stocking through increased ease of the multiple-way correlation.

In some implementations, the placement guidance symbols used for the multiple-way correlation are identical. That is, the placement guidance symbols depicted on one or more containers for a particular product and the placement guidance symbols proximate to the target placement location for the particular product may each be identical with one another. For example, the placement guidance symbols 120, 122, 251, and 252 may be identical in all characteristics, such as design, shape, color, size. Thus, the placement guidance symbols 120, 122, 251, and 252 correlate (e.g., exactly match) in common to a particular product because they are the same. In other implementations the placement guidance symbols may differ (e.g., they are not completely identical), but correlate with one another to correlate in common to the same particular product. For example, the multiple-way placement guidance symbols may share a common design, shape, and color, but vary in size. As another example, the multiple-way placement guidance symbols may share a common size and have a non-identical corresponding design, e.g., a different coloring that varies by shading or different but corresponding visual designs. As yet another example, the multiple-way placement guidance symbols 120, 122, 251, and 252 may differ, but be part of a common visual theme, such as when each of the symbols 120, 122, 251, and 252 depict different items corresponding to a vegetable theme (e.g., a pumpkin, corn, squash, and green bean). In this example, the placement guidance symbols 120, 122, 251, and 252 may match in common to product A or a particular version of product A, while another set of placement guidance symbols depicting items corresponding to, for example, a fruit theme match in common to another product B or another version of product A. In some implementations, some or all of the placement guidance symbols 120, 122, 251, and 252 may respectively depict a differing portion of a single symbol, e.g., quadrants of a circle, halves of a yin and yang symbol, sections of a flower image, or other divisions of one or more symbols into units, pieces, or sub-symbols. The placement guidance symbols 120 and 122 may depict, for example, a bottom corner of an apple icon and the placement guidance symbols 251 and 252 depict the entire apple icon. As another example, each of the placement guidance symbols 120, 122, 251, and 252 may depict, respectively, flower petals, a flower stalk, leaves around the stalk, and earth in which the stalk is planted. These may be, e.g., four portions of a larger composite symbol: a flower planted in the earth.

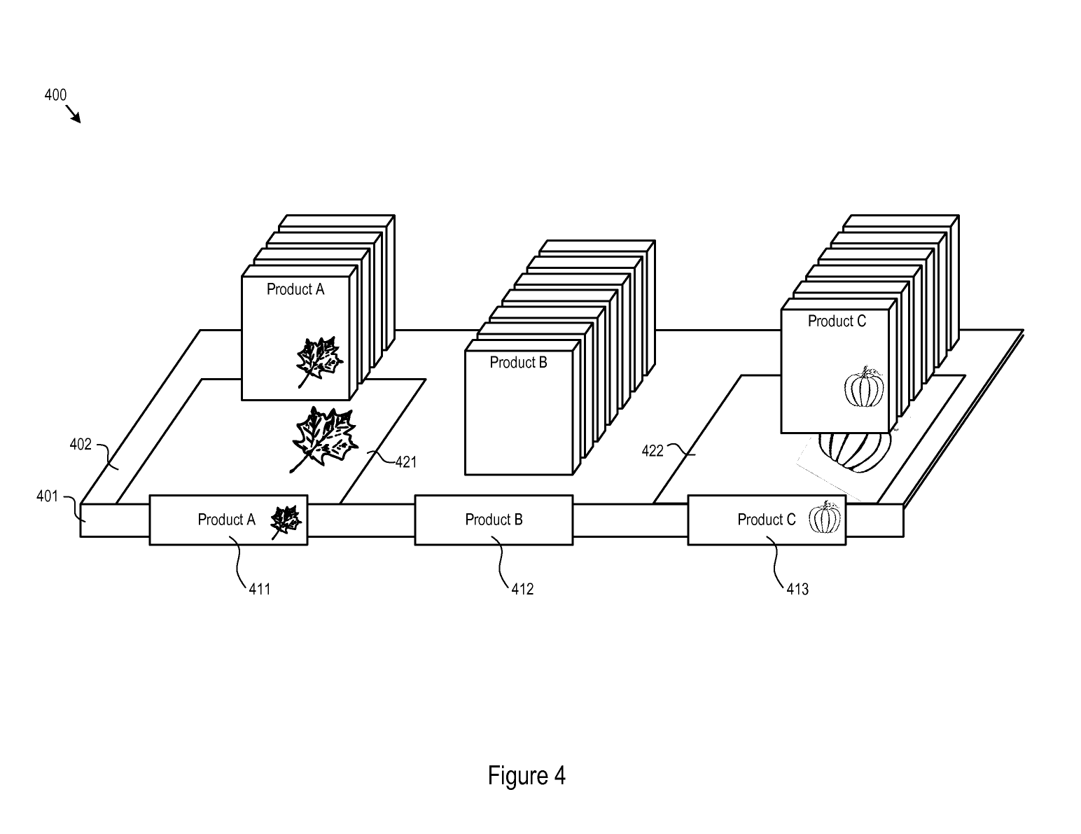

FIG. 4 shows an example of a product placement area 400 including placement guidance symbols for multiple products. FIG. 4 shows a product shelf with a shelf header 401 and a shelf surface 402. Along the shelf header 401 are multiple shelf header labels, including the shelf header labels marked as 411, 412, and 413 in FIG. 4. Each of the shelf header labels 411, 412, and 413 respectively corresponds to Products A, B, and C presented on the product shelf.

A product placement area may be adapted for multiple-way correlation for some, but not all products present in the product placement area. As seen in FIG. 4, the shelf header labels 411 and 413 respectively include a leaf placement guidance symbol associated with product A (or associated with a particular version of product A) and a pumpkin placement guidance symbol associated with product C (or associated with a particular version of product C). The shelf header label 412 associated with product B lacks a placement guidance symbol used for multiple-way correlation in guiding placement of product B. The leaf placement guidance symbol is also depicted on the shelf surface label 421 as well as the product packaging for product A. The various leaf placement guidance symbols together correlate (e.g., exactly match) in common to the product A, i.e., the particular product associated with the leaf placement guidance symbol. Along similar lines, the shelf surface label 422 and product packaging for product C also depict the pumpkin placement guidance symbol, and the various pumpkin placement guidance symbols together correlate in common to the product C. In FIG. 4, the product placement area 400 does not include a shelf surface label for product B, nor do the product packages for product B include a placement guidance symbol used for multiple-way correlation in guiding the placement of product B at a target placement location.

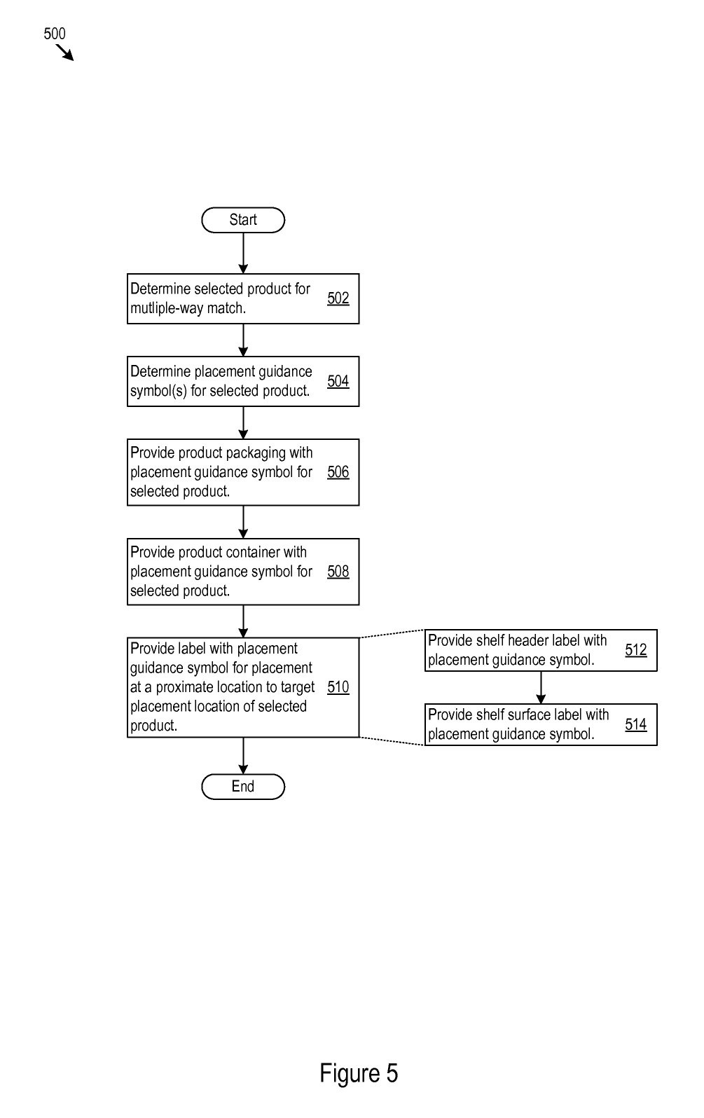

FIG. 5 shows an example of a process 500 for implementing product placement guidance for a particular product. Any entity or combination of entities may perform the process 500. One exemplary entity is a product manufacturer, as described below. Any number of other entities, such as a product designer, third-party manufacturer, product distributor, product retailer, or other entity, may additionally or alternatively perform some or all of the steps in the process 500 described below.

The product manufacturer may determine a selected product for the multiple-way correlation (502). In that regard, the product manufacturer may apply any number of selection criteria for determining the selected criteria. The selection criteria may specify selecting one or more products that fall below a predetermined sales threshold, such as a particular sales amount, rate, volume, or other sales indicator. As another example, the selection criteria may specify selecting a particular product based on the accuracy in stocking the particular product, e.g., when the particular product has been improperly stocked more than a threshold number of times or exceeds an improper stocking rate. As additional examples, the selection criteria may specify selecting predetermined product types or categories, time-sensitive products such as perishable items and seasonal or limited edition products, products with high obsolescence or high return rates (e.g., beyond a particular obsolescence or return rate threshold), products with a limited supply categorization or below a particular supply threshold, products subject to an increased marketing investments or promotion, and more. The product manufacturer may determine a placement guidance symbol for the selected product (504). The placement guidance symbol may indicate a particular characteristic or attribute of the selected product. The placement guidance symbol may include a particular shape, color, design, or other characteristic that facilitates recognition or the selected product, whether for placement of the product or for consumer recognition. The product manufacturer may implement the placement guidance symbol to exclude representations of text or typography, such that the placement guidance symbol is different from or excludes a bar code, QR code, item number, or other data representation associated with the selected product. In some implementations, the product manufacturer may determine the placement guidance symbol as a simple, non-complex visual icon, such as the leaf placement guidance symbol or pumpkin placement guidance symbol presented in FIGS. 1-4, or any other simple visual image.

Continuing the process 500, the product manufacturer may provide packaging for the selected product that includes the determined placement guidance symbol (504). Providing packaging for the selected product can include designing a product package that displays the symbol in an externally visible manner. The design may specify affixing the placement guidance symbol to an existing product package for the selected product, such as through a sticker or other labeling mechanism.

The product manufacturer may also provide a product container for that selected product that externally depicts the determined placement guidance symbol (506). The product container may store multiple product packages for the selected product, e.g., in the form of a corrugated box. The product container may include multiple instances of the placement guidance symbol. For example, the product manager may provide a product container such that at least one instance of the placement guidance symbol is externally visible when the product container is placed in storage, placed for transit or distribution, carted for stocking by a retailer, or according to any other visibility scenarios or criteria.

The product manufacturer may provide a label with the multiple-way placement guidance symbol (510). The product manufacturer may adapt the label for placement a particular location proximate to a target placement location for the selected product. For instance, the product manufacturer may provide a shelf header label (512) and provide a shelf surface label (514) with the determined placement guidance symbol. Additional or alternative labels are possible, and the product manufacturer may specifically adapt the labels according to the target placement area for the selected product. For instance, when the target placement area of a particular product is a particular hanger rack, the product manufacturer may provide a label for positioning above or below the rack, that hangs upon the hanger rack, and/or at another particular location specific to the hanger rack, to visibly display the placement guidance symbol.

The product manufacturer may provide multiple labels depicting the placement guidance symbol for a particular target placement location for the selected product. In that regard, the product manufacturer may provide a first label adapted for placement at a first location proximate to the target placement location (e.g., a shelf header label) and a second label adapted for placement at a second location different from the first and proximate to the target placement location (e.g., a shelf surface label). Accordingly, a product placement area may include multiple, redundant placement guidance symbols for use in the multiple-way correlation that guides placement of the selected product at a target placement location in the product placement area. These multiple, redundant placement guidance symbols depicted in the labels, along with the corresponding (e.g., identical) placement guidance symbols externally visible on the product package and/or product container, visually guide placement of the product at the target placement location for the selected product.

For any element depicting the system, the product manufacturer may determine a selected position for the multiple-way placement guidance symbol on the element. These elements include the product package, product container, one or more labels for placement proximate to a target placement location, or any other product-related or display element depicting the symbol. The product manufacturer may use any number of visibility criteria for determining the selected position of the multiple-way placement guidance symbol on a particular element, such as those described above in connection with the product container and shelf surface label.

The product manufacturer may provide elements depicting the multiple-way placement guidance symbol in various ways. In some scenarios, the product manufacturer may cause placement of one or more labels with the placement guidance symbol proximate to a target placement location for the selected product. For example, the product manufacture may provide a product stock kit that includes the one or more labels including the placement guidance symbol and adapted for placement a various proximate locations to the target placement location. The product stock kit may include product package or the product container. Or, the product manufacturer may cause shipment of any combination of the product container, product packages, and labels to a common point of sale for the selected product. In some scenarios, the product manufacturer may cause such shipment by providing a design for the product package, product container, or labels to a third-party manufacturer or distributor that subsequently produces or ships the actual product package, product container, or labels. And as indicated above, any number or combination of entities may perform some or all of the various steps in the process 500.

Note that the example process 500 supports up to a four-way correlation because there are four different placement guidance symbol locations. However, additional, fewer, or different symbols may be provided to implement additional or fewer correlations. For instance, there may be only two different placement guidance symbol locations (e.g., product container and shelf surface) to support a two-way correlation. There may be an additional placement guidance symbol provided on the floor proximate the target placement location to provide up to a five-way correlation with the placement guidance symbols 122, 120, 251, and 252. Other variations are possible.

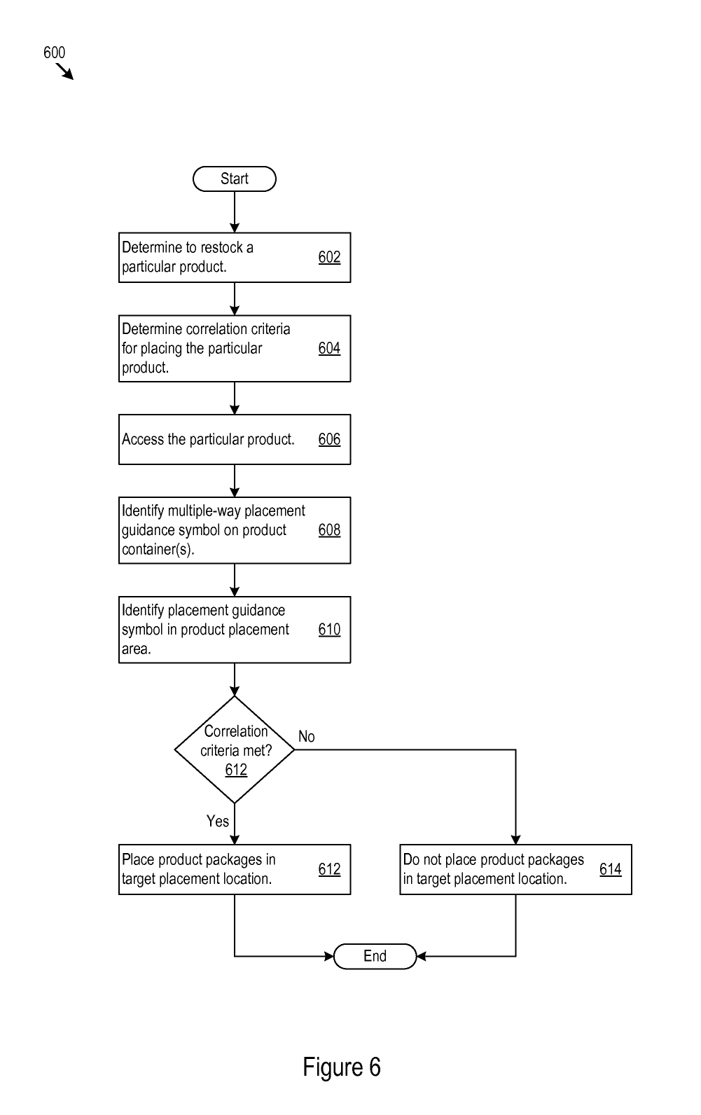

FIG. 6 shows an example of a process 600 for executing product placement using multiple placement guidance symbols. The process 600 may be performed by any entity to help guide placement of a product at a target placement location. For example, a retailer may perform the process 600 to stock a particular product at a target placement location on a sales floor.

The retailer may determine to restock a particular product (602). The retailer may make such a determination by accessing inventory data or determining that the amount of the particular product at a particular product presentment area has fallen below a stocking threshold. The retailer may determine the correlation criteria sufficient for placing the product at a target placement location (604). For example, the correlation criteria may be at least a three way correlation among four possible correlations, with at least one correlation being from the product container or product package, and at least one correlation being from the shelf header or shelf surface. As another example, the correlation criteria may be a four-way exact match of the four available placement guidance symbols.

The retailer may access the particular product (606). In that regard, the retailer may access the product from a storage room or receive a shipment of the particular product from a product manufacturer or distributor. The storeroom or shipment may include a product container storing multiple product packages for the product. The product container and/or multiple product packages externally display a multiple-way placement guidance symbol associated with the particular product, and the retailer may identify the multiple-way placement guidance symbol (608).

The retailer may identify a placement guidance symbol in a product placement area (608) and determine whether a multiple way correlation exists between the symbols on the product containers and symbols in a product placement area that satisfies the correlation criteria (612). That is, the retailer may determine that a placement guidance symbol externally visible from one or more containers storing the particular product and the one or more placement guidance symbols presented in a product placement area correlate in common to the particular product. As one exemplary correlation, the retailer may determine that placement guidance symbols externally visible on multiple different product containers for the particular product correlate with a placement guidance symbol shown on a label proximate to a target placement location of the particular product. The retailer may correlate the placement guidance symbol shown on a product package, product container, or both, with one or more labels depicting the placement guidance symbol and placed proximate to the target placement location for the particular product.

When the retailer determines a multiple-way correlation satisfying the correlation criteria, the retailer places the particular product at the target placement location for the particular product, e.g., through placement of the product packages (612). When the retailer determines no correlation that satisfies the correlation criteria exists, the retailer may not place the product at the target placement location, e.g., by foregoing placement of the product packages.

Various implementations have been specifically described. However, many other implementations are also possible.

What is claimed is:

1. A method comprising:
providing:
packaging for a product, the packaging comprising a first placement guidance symbol that is externally visible on the packaging and that is associated with the product; or
a container for storing the packaging for the product, the container comprising a second placement guidance symbol that is externally visible on the container and that is associated with the product; or
both the packaging and the container; and
providing a first label adapted for placement at a first location proximate to a target placement location for the product, the first label comprising a third placement guidance symbol associated with the product, and where:
the first placement guidance symbol, when the packaging with the first placement guidance symbol is provided, the second placement guidance symbol, when the container with the second placement guidance symbol is provided, and the third placement guidance symbol each comprise a non-textual graphical element correlating in common to the product.

2. The method of claim 1, further comprising:
providing a second label adapted for placement at a second location different than the first location, the second location also proximate to the target placement location for the product, the second label comprising a fourth placement guidance symbol associated with the product.

3. The method of claim 1, where providing the packaging, the container, or both, and providing the first label comprise:
causing shipment of the packaging, when the packaging with the first placement guidance symbol is provided, the container, when the container with the second placement guidance symbol is provided, and the first label to a common point of sale for the product.

4. The method of claim 1, where the first placement guidance symbol, when the packaging with the first placement guidance symbol is provided, the second placement guidance symbol, when the container with the second placement guidance symbol is provided, and the third placement guidance symbol are identical.

5. The method of claim 1, where the first placement guidance symbol, when the packaging with the first placement guidance symbol is provided, the second placement guidance symbol, when the container with the second placement guidance symbol is provided, and the third placement guidance symbol are not identical, but correlate with one another in common to the product.

6. The method of claim 1, where first label comprises a shelf header label.

7. The method of claim 1, where the first label comprises a shelf surface label.

8. A product stock kit comprising:
a first label adapted for placement at a first location proximate to a target placement location, the first label comprising a first placement guidance symbol specific to a particular product; and
a second label including a second placement guidance symbol also specific to the particular product, the second label adapted for placement at a second location different than the first location, the second location also proximate to the target placement location,
the first and second placement guidance symbols visually adapted to guide stocking of the product to the target placement location.

9. The product stock kit of claim 8, further comprising:
product packaging comprising a third placement guidance symbol specific to the particular product, the third placement guidance symbol externally visible on a surface of the product packaging.

10. The product stock kit of claim 9, further comprising:
a container adapted for storing the product packaging, the container comprising a fourth placement guidance symbol specific to the particular product.

11. The product stock kit of claim 10, where any two or more of the first, second, third, and fourth placement guidance symbols are the same.

12. The product stock kit of claim 8, where first label comprises a shelf header label.

13. The product stock kit of claim 8, where the first label comprises a shelf surface label.

14. A method comprising:
determining a multiple-way correlation among symbols associated with a particular product,
the symbols comprising:
a first symbol on a first label proximate to a target placement location for the particular product; and
multiple additional symbols visible externally on multiple different product containers for the particular product;
the multiple-way correlation comprising:
correlations between the first symbol and the multiple additional symbols; and
when the multiple-way correlation exists, placing the particular product at the target placement location for the particular product.

15. The method of claim 14, where the multiple different product containers comprise a product package and a container adapted to hold multiple of the product packages.

16. The method of claim 14, where first label comprises a shelf header label.

17. The method of claim 14, where the first label comprises a shelf surface label.

18. The method of claim 14, where the symbols further comprise:
a second symbol in addition to the first symbol, the second symbol on a second label proximate to the target placement location for the particular product; and where the multiple-way correlation comprises:
correlations between the first symbol, second symbol, and the multiple additional symbols.

19. The method of claim 18, where the first symbol comprises a shelf header label and the second label comprises a shelf surface label.

20. The method of claim 18, where the first symbol, second symbol, and multiple additional symbols are identical.
